(19) United States
(12) Patent Application Publication
(10) Pub. No.: US 2025/0306718 A1
(43) Pub. Date: Oct. 2, 2025

(54) TEXTILE-INTEGRATED WEARABLE SENSOR FOR MOTION-ARTIFACT-FREE HAND GESTURE INPUTS AND RECOGNITIONS

(71) Applicant: Meta Platforms Technologies, LLC, Menlo Park, CA (US)

(72) Inventors: Junyi Zhao, Redmond, WA (US); Pornthep Preechayasomboon, Redmond, WA (US); Tyler Henry Christensen, Monroe, WA (US); Amirhossein Hajiagha Memar, Woodinville, WA (US); Zhenzhen Shen, Kirkland, WA (US); Nicholas Colonnese, Kirkland, WA (US); Michael Tawfik Khbeis, Federal Way, WA (US); Mengjia Zhu, Kirkland, WA (US)

(21) Appl. No.: 19/080,702

(22) Filed: Mar. 14, 2025

Related U.S. Application Data
(60) Provisional application No. 63/570,192, filed on Mar. 26, 2024.
(60) Provisional application No. 63/575,560, filed on Apr. 5, 2024.

(51) Int. Cl. G06F 3/044; G06F 3/01

(52) U.S. Cl. CPC G06F 3/044; G06F 3/016; G06F 3/017

(57) ABSTRACT

A capacitive sensor for use in a wearable or flexible input device is described. The capacitive sensor includes a dielectric knitted core comprising deformable polymer patches deposited on a top surface of the dielectric knitted core, conductive electrode layers with stretchable electrodes positioned on the top and bottom surfaces of the dielectric knitted core, and a conductive textile shielding layer on each of the conductive electrode layers. The deformable polymer patches stiffen regions of the dielectric knitted core corresponding to the stretchable electrodes to limit strain on the stretchable electrodes as a wearer of the input device moves and deforms the input device during use. Moreover, the conductive electrode layers and conductive textile shielding layers comprise openings around the stretchable electrodes that redistribute strain away from the stretchable electrodes. These features limit motion artifacts while maintaining the flexibility and comfortability of the input device.

### CROSS-REFERENCE TO RELATED APPLICATIONS

This application claims the benefit of U.S. Provisional Application No. 63/575,560,filed Apr. 5, 2024, entitled “Textile-Integrated Wearable Sensor For Motion-Artifact-Free Hand Gesture Inputs And Recognitions,” and U.S. Provisional Application No. 63/570, 192, filed Mar. 26, 2024, entitled “Textile-Integrated Wearable Sensor For Motion-Artifact-Free Hand Gesture Inputs And Recognitions,” each of which is herein fully incorporated by reference in its respective entirety.

### TECHNICAL FIELD

This relates generally to wearable input sensors, including but not limited to techniques for manufacturing and operating textile-integrated capacitive sensors in wearable or flexible input devices. The techniques described herein limit motion artifacts (i.e., unwanted signals and noise) produced by physical movement and deformation of the input devices during use.

### BACKGROUND

Traditional input devices such as keyboards, mice, touch screens, and handheld controllers are limited in their ability to provide always-available, high-dimensional, discreet, and low-friction input. On the other hand, wearable input sensors shift the input control surfaces from external devices to the human body. Wearable input sensors are always available, feature complex high-dimensional input (especially when designed for the hands), and provide private and intuitive interactions that leverage the proprioception and passive haptics of one's own body. Accordingly, wearable input sensors eliminate the need for visual, audio, or active haptic feedback interaction loops, which creates a more streamlined and natural user experience.

Advances in wearable input sensors have enabled ubiquitous touch interactions with the body. Several different sensing mechanisms have been studied for touch interactions. For example, inertial measurement units (IMUs) have been used to track motion by detecting the movements of the finger and/or hand. Optical methods such as depth cameras and photoreflective sensors have been used to visualize gesture changes and deformations on the skin. In addition to touch and motion, resistive and capacitive sensors have been leveraged to detect multi-level contact force input. Among those sensing mechanisms, capacitive sensors feature low power consumption, high sensitivity, better temperature performance, and low cost, whereas lacking inherent tactile feedback and are susceptible to electromagnetic noise.

Textiles have emerged as a promising platform for constructing wearable electronics, seamlessly integrating electronic components like sensors, actuators, and circuits into fabrics to craft smart garments or accessories. This fusion of textiles and electronics offers numerous advantages, including enhanced flexibility, comfort, and breathability, making wearable electronics increasingly practical and convenient for everyday use.

### SUMMARY

Techniques for combining wearable input sensors with textiles to develop wearable or flexible input devices exist but are not yet sufficient for accurately and conveniently integrating wearable or flexible input devices into everyday use. For example, conventional techniques for integrating touch sensors with textiles primarily involve attaching sensor patches onto the textile and embedding sensors into textiles using functional yams/fibers through knitting. However, patch-like sensors add bulkiness and compromise the integrity of wearable devices, while knitted sensors are constrained by complex fabrication processes and limited knitting resolutions. In accordance with this realization, this disclosure teaches a facile hybrid manufacturing method that combines direct on-textile fabrication with multi-layer lamination. In this approach, textiles are conceptualized as integral dielectric cores within the capacitive sensor architecture rather than mere supportive substrates, which are sandwiched by patterned electrode layouts to allow customization and up-scaling of pixel density.

Moreover, for wearable touch sensors integrated with textiles, motion artifacts might compromise the accuracy and reliability of sensor readings, interfering with device functionality and user experience. Motion artifacts are excess signals (i.e., noise) introduced by when a user moves and deforms the textile during use (e.g., by bending her fingers, arms, etc. to provide the input to the sensor). Encapsulating textiles with silicone has been presented as an effective method for mitigating motion artifacts. Unfortunately, employing a full-area composite results in significant alterations to the physical properties of the textile, thereby compromising its inherent characteristics, including softness, breathability, and wearing conformability. To address these drawbacks, this disclosure also introduces a strategy where isolated polymer patches or domes are patterned onto textiles. In this strategy, the polymer patches can mitigate motion artifacts by locally strain-locking the sensing portions of the textile and, because the polymer patches are isolated to sensing areas, the polymer patches do not significantly change the physical properties of the textile.

Finally, conventional touch sensors are constructed into patches with a flat appearance to assure human compatibility. However, this configuration often necessitates visual focus to pinpoint the exact sensing region, potentially hindering efficient inter-actions and disrupting the user experience's fluidity. In contrast, textile-integrated force sensors described herein utilize the polymer patches described above as tactile markers that facilitate the navigation of users' fingers to discern the precise locations of pixels, thereby improving usability for private interactions in public and cognitively sensitive environments. Accordingly, textile-integrated force sensors described herein leverage the advantages of capacitive sensors while addressing their challenges using a high-density array with programmable stiff polymer domes that provide both passive tactile feedback and motion artifact tolerance.

A first example of the textile-integrated force sensor is a capacitive sensor configured to be used in a device. The capacitive sensor comprises a dielectric knitted core, a first conductive electrode layer positioned on a top surface of the dielectric knitted core, and a second conductive electrode layer positioned on a bottom surface of the dielectric knitted core. A first portion of each deformable polymer patch extends above the top surface and a second portion of each deformable polymer patch penetrates the dielectric knitted core. Moreover, the first and second conductive electrode layers respectively comprise first and second pluralities of stretchable electrodes. The plurality of deformable polymer patches is configured to stiffen regions of the dielectric knitted core corresponding to the first and second pluralities of stretchable electrodes to limit strain on the first and second pluralities of stretchable electrodes.

Moreover, this disclosure is directed to a method of operating the capacitive sensor described above. The method comprises providing a signal from a wearable device to the capacitive sensor.

This disclosure is also directed to a system comprising an extended-reality device that is in communication with a signal processor and a wearable input device that includes a capacitive sensor, such as the capacitive sensor described above, and the signal processor for receiving inputs provided by a wearer.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1I illustrate examples of wearable and flexible input devices that utilize textile-integrated sensors, in accordance with some embodiments.

FIGS. 2A-2E illustrate example interactions that are possible with the textile- integrated sensors, in accordance with some embodiments.

FIG. 3 illustrates a top perspective view of an exemplary T-shaped textile- integrated sensor, in accordance with some embodiments.

FIGS. 4A and 4B illustrate cross-sectional side views of the textile-integrated sensor, in accordance with some embodiments.

FIG. 5 illustrates an exploded perspective view of the layers of a textile-integrated sensor, such as the ones illustrated in FIGS. 3, 4A, and 4B, in accordance with some embodiments.

FIGS. 6A 6B, 6C-1, and 6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read- only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Example Wearable and Flexible Input Devices

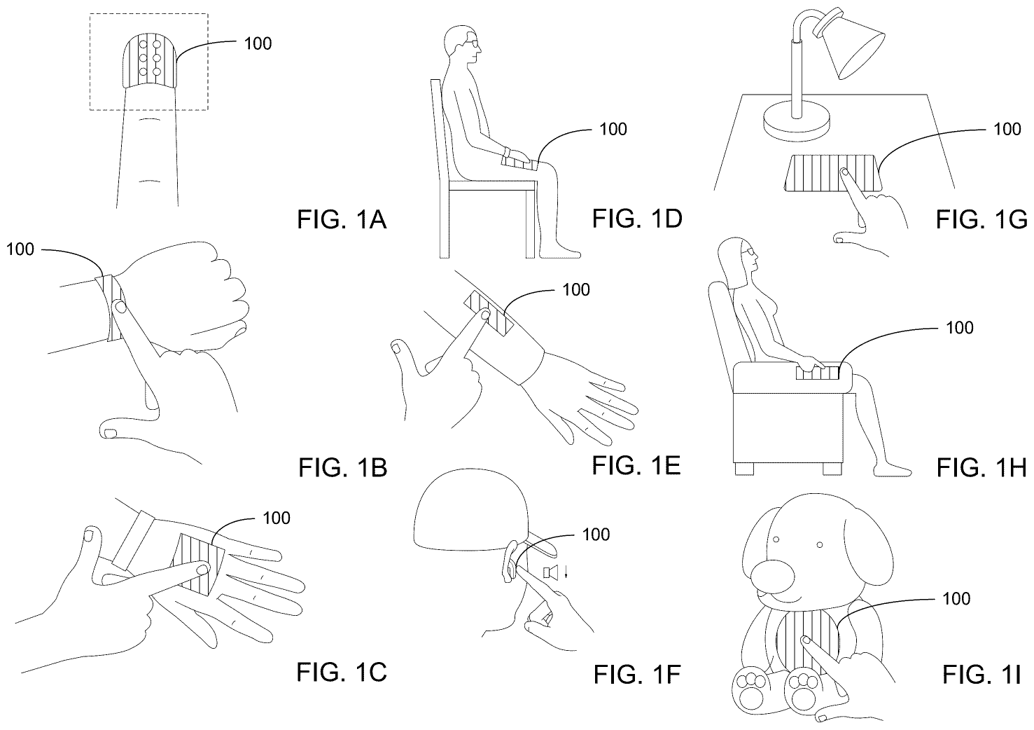

Referring now to the figures, FIGS. 1A-1I illustrate examples of wearable and flexible input devices that utilize textile-integrated sensors, in accordance with some embodiments. The wearable input devices can include textile-integrated force sensors 100 on a user's fingertips, hands, wrists, etc. For example, a textile-integrated force sensor 100 can be wrapped around the user's index finger, as depicted in FIG. 1A. Similarly, FIG. 1B illustrates that the sensor 100 can be incorporated into a wristband and worn on the user's wrist, and FIG. 1C illustrates that the sensor 100 can be made into a flexible patch that is coupled to the back of a user's hand. The textile-integrated force sensor 100 can also be a soft or curved substrate sewn into clothing worn by the user (e.g., a sleeve, a pantleg, or a glove), or integrated in a wristband. FIGS. 1D and 1E depict the sensor 100 being sewn into the user's pants and shirt sleeve, while FIG. 1F illustrates the sensor 100 integrated with an earbud worn by the user.

Additionally, flexible input devices can include textile-integrated force sensors 100 on consumer electronics (e.g., appliances, toys, etc.) and furniture. FIGS. 1G and 1H illustrate the textile-integrated force sensor 100 being incorporated into household furniture such as a desk or the armrest of a chair. The user can use these devices to conveniently control lights in a living room, change channels on a television, etc. FIG. 1I depicts the sensor 100 integrated in a stuffed animal.

The textile-integrated force sensors 100 described herein have a thickness between 1 mm and 2.0 mm. In some embodiments, the sensors 100 have a thickness of 1.5 mm. Even though the sensors 100 are very thin, the sensors 100 can withstand a force input of up to 25 N. In some embodiments, the sensors 100 can withstand a force input of up to 20 N. Accordingly, the sensors 100 can detect force inputs between 0.01 N and 7 N. That is, the sensors 100 can enhance tactile interactions by facilitating diverse interaction modalities with varied force inputs (e.g., force inputs between 0.05 N and 5 N) such as tapping and force pressing.

Furthermore, the sensors 100 described herein have a capacitive sensor architecture that facilitates high spatial resolution sensing. Particularly, the sensors 100 described herein can detect a user's touch input location with a millimeter scale spatial resolution. This is accomplished, in part, by a high-density sensor pixel array of 25 pixels per cm². In some embodiments, the sensors 100 include multiple 12-bit capacitive channels.

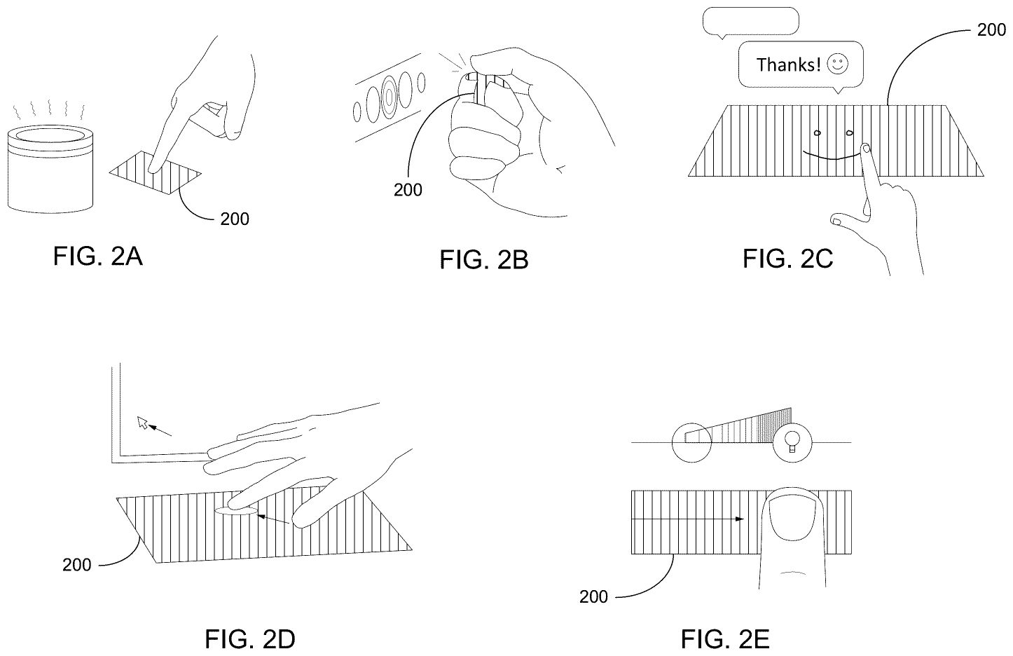

FIGS. 2A-2E illustrate example interactions that are possible with the textile-integrated sensors, in accordance with some embodiments. Textile-integrated force sensors 200 described herein provide both binary contact and analog force inputs, enabling a wide range of applications. For instance, the sensors 200 can provide stateful touch inputs, illustrated in FIG. 2A, which are used to identify the beginnings and ends of interactions. That is, the user's touch begins an interaction if the state of the touch satisfies a predetermined threshold. Likewise, the user's touch ends the interaction of the state of the touch enters a lower threshold.

The sensors 200 can also provide micro-gestures, which are short strokes in cardinal directions on the sensor 200 to navigate a user interface. The micro-gestures can be provided in a context such as the one illustrated in FIG. 2B, where the user wears a T-shaped sensor 200 on her finger and provides inputs with her thumb. In some embodiments, if the user does not move her finger from the initial location, under a certain threshold, and within 350 milliseconds, then the gesture is a tap instead of a stroke.

The sensors 200 described herein can also provide stroke-based gestures, which are series of strokes that the user can draw on the sensor area to be used as shortcuts, such as drawing a check mark for completing a to-do list item, or as text input by directly drawing the letter. These stroke-based gestures are depicted in FIG. 2C. Similarly, FIG. 2D illustrates that the sensors 200 can enable 2D continuous input, in which the location of the user's finger is continuously tracked to drive a cursor. Finally, FIG. 2E provides an example of 1D continuous input, in which one dimension of the 2D input is isolated or disabled.

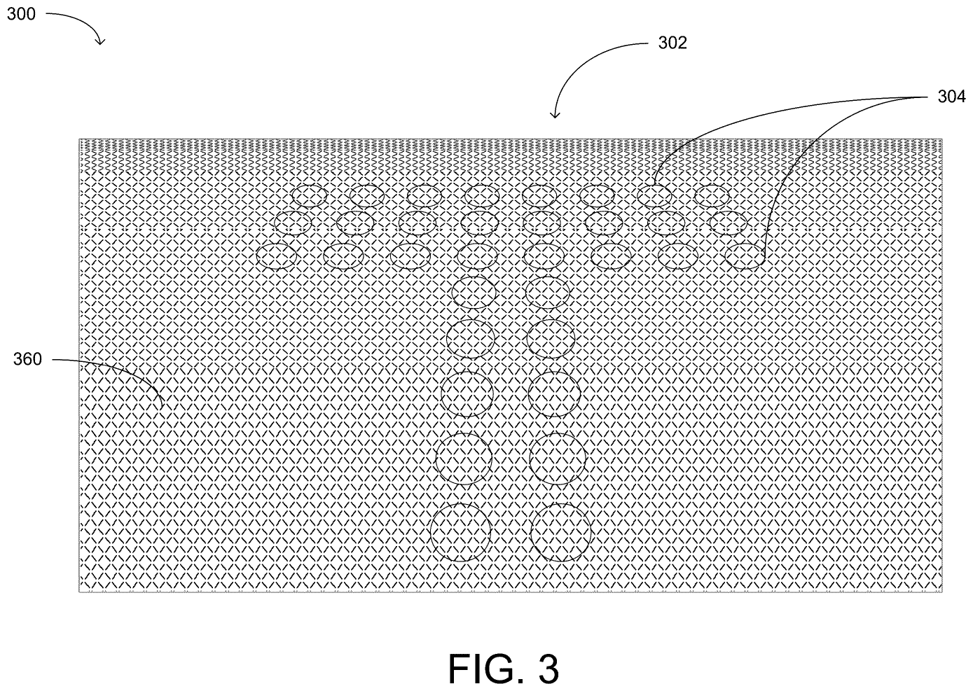

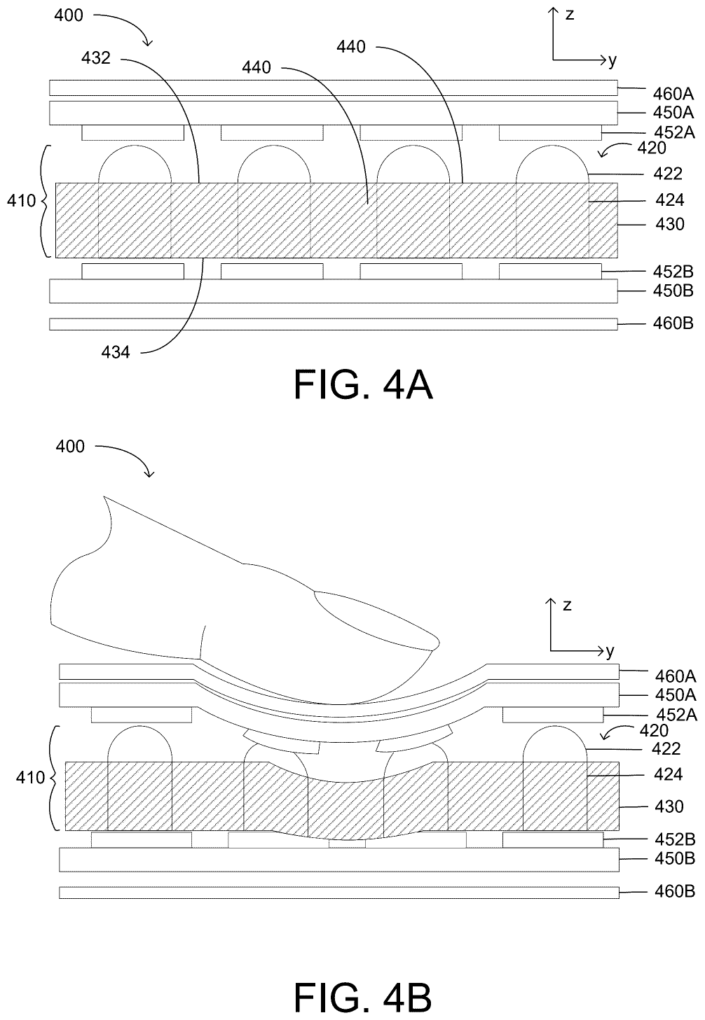

FIG. 3 illustrates a top perspective view of an exemplary T-shaped textile-integrated sensor, in accordance with some embodiments. FIG. 3 depicts that the textile-integrated sensor 300 includes an array 302 of tactile markers 304 that can be felt through a conductive textile shielding layer 360. Each tactile marker 304 corresponds to a deformable polymer patch or dome (such as the polymer domes 420 in FIGS. 4A and 4B) that is covered by a conductive electrode layer (such as the conductive electrode layer 450A in FIGS. 4A and 4B) and a conductive textile shielding layer 360. In the embodiment shown in FIG. 3, the tactile markers 304 (and thus the stretchable electrodes and the polymer domes) are arranged in a T-shaped array 302. This T-shaped array 302 is well suited for integration with wearable input devices that are worn on the user's finger, such as those illustrated in FIGS. 1A and 2B.

As discussed above, the spatial resolution of the touch sensor array facilitates the capability of micro-gesture recognition induced by subtle finger rubbing and the dynamic tracking of finger location in a 2D plane. While conventional wearable input sensors have resolutions of 1×3 pixels per finger, 2×2 pixels per patch, 7 pixels per finger, 2×4 pixels per finger, 3×3 pixels per nail, the textile-integrated sensor accomplishes a much higher resolution because the layered structure of the textile-integrated sensor allows a higher density of pixels. In particular, textile- integrated sensors described herein can have a density of 25 pixels per cm², which can be used in a wearable input sensor, such as the sensor 300 in FIG. 3, having 8×8 pixels. This high pixel density allows the textile-integrated sensor 300 to function in a versatile manner (e.g., in the manner expected of a laptop trackpad) in wearable or flexible input devices.

FIGS. 4A and 4B illustrate cross-sectional side views of a textile-integrated sensor, in accordance with some embodiments. The textile-integrated sensor 400 (which can also be referred to as the textile-integrated force sensor 400, the textile-integrated capacitive sensor 400, and the capacitive sensor 400) is a capacitive sensor with a knitted textile compressive core 410 sandwiched between two layers 450A and 450B of printed silver electrodes and conductive textile shielding layers 460A and 460B. The sensor 400 is the same as the sensors 100, 200, and 300 described above.

The knitted textile compressive core 410 (which can also be referred to as the dielectric knitted core 410) is a knitted textile 430 with deformable polymer patches 420. In some embodiments, the knitted textile 430 is made of a polyester and spandex blend. For example, the knitted textile 430 can be a blend of 86% polyester and 14% spandex. This blend makes the capacitive sensor 400 elastic and facilitates compression displacement. Specifically, this knitted textile 430 can facilitate up to 70% displacement in response to a 10 N input, which provides compressible space along the z-axis and, thus, alters capacitance in response to the force input. Advantageously, the polymer patches 420 integrated within the knitted textile 430 can boost sensor performance by augmenting the compression capability of the composite dielectric core and reducing the hysteresis during reversible response, enabling an approximate displacement of 80% at 10 N.

In some embodiments, the polymer patches 420 are made of silicone rubber. Optionally, the polymer patches 420 are made of Bluesil RTV 3040 silicone rubber. Silicone rubber has a pot life of approximately 2 hours, which provides ample time for material processing. This ample time, in turn, facilitates intricate and large-scale pattern production in a single session. Silicone rubber also has a high viscosity of approximately 50,000 cP, which minimizes bleeding of the polymer patches 420 (before they are cured) into the fibers of the knitted textile 430. Finally, silicone rubber has notable tensile strength (approximately 920 psi), is an order of magnitude harder than the pristine knitted textile 430 (i.e., the knitted textile 430 without the polymer patches 420), and a high modulus that enhances the strain-locking effectiveness of the polymer patches 420 and, thus, improves the motion artifact tolerance of the capacitive sensor 400.

In FIGS. 4A and 4B, the deformable polymer patches 420 are domed cylinders and can be referred to as polymer domes 420. In some embodiments, the polymer domes 420 have a height-to-diameter ratio (with height being measured along the z-axis and diameter being measured along one or both of the x-axis and the y-axis) between 0.1 and 0.3. Optionally, the polymer domes 420 have a height-to-diameter ratio of 0.2. Optionally, the polymer domes 420 have a diameter between 1490 μm and 1590 μm.

As depicted in FIGS. 4A and 4B, the polymer domes 420 have two portions: a first portion 422 that is above the top surface 432 of the knitted textile 430 and a second portion 424 that is between the top surface 432 and the bottom surface 434 of the knitted textile 430 (i.e., the second portion 424 of the polymer domes 420 penetrates the knitted textile 430). The polymer domes 420 are integrated within the knitted textile 430 to form isolated polymer composites that locally stiffen the sensing areas 440 (which can also be referred to as sensing regions 440 or regions 440) of the dielectric knitted core 410, which are the regions 440 of the dielectric knitted core 410 that correspond to each electrode 452A, 452B in the conductive electrode layers 450A, 450B. Specifically, in embodiments where the capacitive sensor 400 is stacked such that the electrodes 452A are right above the first portions 422 of the polymer domes 420 and the electrodes 452B are just below the second portions 424 of the polymer domes 420, the regions 440 of the dielectric knitted core 410 are the portions of the knitted textile 430 that circumferentially surround the polymer domes 420.

The polymer domes 420 improve the motion-artifact tolerance of the capacitive sensor 400 by redefining the strain distribution within the dielectric knitted core 410. In particular, under universal deformations (e.g., bending, stretching), the structural elongation predominantly occurs in the pristine knitted textile 430, while the polymer domes 420 substantially constrain distortion of the sensing areas 440 and, thus, the stretchable electrodes 452A, 452B. In some embodiments, the polymer domes 420 also stiffen and strain lock regions of the conductive electrode layers 450A, 450B and the conductive textile shielding layers 460A, 460B that correspond to the stretchable electrodes 452A, 452B.

Additionally, the first portion 422 of the polymer domes 420 form bumps or markers in the capacitive sensor 400 (shown in FIG. 4A) that can provide tactile feedback to the user. Meaning, the first portion 422 of the polymer domes 420 can facilitate the navigation of users' fingers to discern the precise locations of pixels, thereby improving usability for private interactions in public and cognitively sensitive environments.

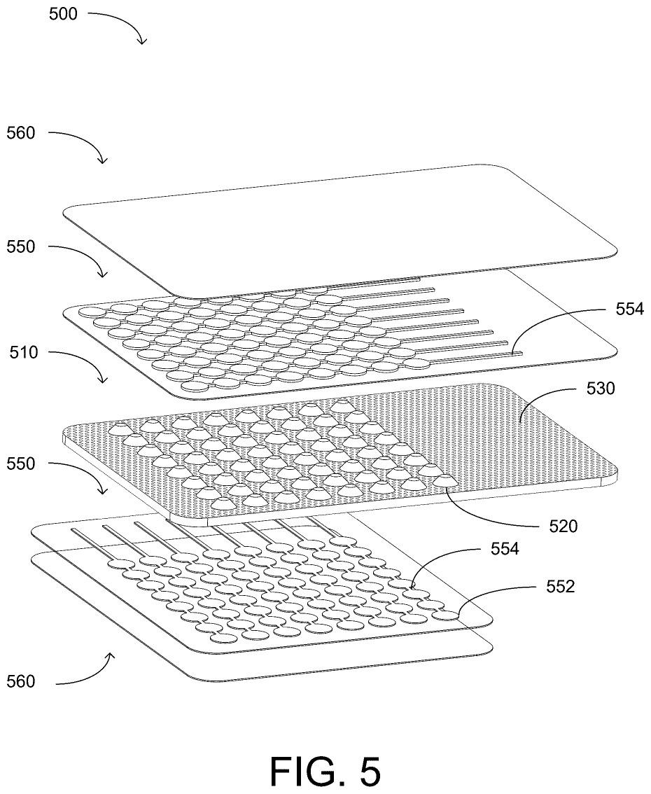

The capacitive sensor 400 also includes conductive electrode layers 450A, 450B above and below the dielectric knitted core 410. The first (i.e., top) conductive electrode layer 450A has stretchable electrodes 452A. Likewise, the second (i.e., bottom) conductive electrode layer 450B has stretchable electrodes 452B. In some embodiments, the stretchable electrodes 452A, 452B have a width (measured along one or both of the x-axis and the y-axis) between 260 μm and 360 μm. Optionally, the stretchable electrodes 452A, 452B have a width of 310 μm. The conductive electrode layers 450A, 450B can also include stretchable interconnects (e.g., stretchable interconnects 554A, 554B in FIG. 5B).

The stretchable electrodes 452A, 452B can be made of a stretchable silver ink, such as SS 1109 from ACI Materials. Unlike other elastic conductor materials such as conjugated polymer PEDOT:PSS, sliver nanowires, carbon-filled silicone, and liquid metal, stretchable silver ink adheres exceptionally well to thermoplastic urethanes, has excellent resistivity, and is compatible for use in diverse patterning methods such as screen printing and syringe dispensing.

FIGS. 4A and 4B also depict that the capacitive sensor 400 has conductive shielding layers 460A, 460B on each conductive electrode layer 450A, 450B. In some embodiments, each conductive shielding layer 460A, 460B is made of a conductive fabric tape, such as 3M's 5113 FT conductive fabric tape. Conductive fabric tape grounds the capacitive sensor 400 while also providing electromagnetic interface (EMI) shielding. Moreover, conductive fabric tape is thin (having a thickness between 40 μm and 60 μm or a thickness of 50 μm), which helps keep the capacitive sensor 400 thin while also providing a desirable fabric texture for users.

In some embodiments, the conductive electrode layers 450A, 450B and the conductive shielding layers 460A, 460B include structural openings. These openings improve the flexibility and comfort of the capacitive sensor 400 because the incorporation of multiple functional layers (i.e., electrode layers, shielding layers, bonding materials, and encapsulation) in skin-interfaced touch sensors such as the capacitive sensor 400 often hampers natural hand and finger flexibility and compromises the comfort of the user. The openings are oriented in the conductive electrode layers 450A, 450B and the conductive shielding layers 460A, 460B to distribute strain away from the sensing regions (i.e., the regions that surround the electrodes 452A, 452B). The openings also provide secondary resilience against motion artifacts while maintaining the mechanical flexibility of the capacitive sensor 400 and minimizing encumbrance to the user. In some embodiments, the openings comprise narrow cross or plus shaped cuts positioned in between electrodes 452A, 452B. The openings guide the orientation of creases in the capacitive sensor 500 and, thus, prevent interference with the sensing pixels. The openings can have a width that is between 80 μm and 120 μm. Optionally, the openings have a width that is 100 μm. The cross or plus shaped openings facilitate bi-axial deformation flexibility in wearable contexts while still allowing the conductive electrode layers 450A, 450B and the conductive shielding layers 460A, 460B to protect the stretchable electrodes 452A, 452B.

FIG. 5 illustrates an exploded perspective view of the layers of a textile-integrated sensor, such as the ones illustrated in FIGS. 3, 4A, and 4B, in accordance with some embodiments. The textile-integrated sensor 500 in FIG. 5 is the same as the textile-integrated sensor described above with respect to FIGS. 1-4B. The textile-integrated sensor 500 or capacitive sensor 500 is symmetrical about the dielectric knitted core 510, with the outermost layers being the conductive textile shielding layers 560. The conductive textile shielding layers 560 are adjacent to the conductive electrode layers 550, which include a plurality of electrodes 552 and interconnects 554. Finally, the dielectric knitted core 510, which is made up of the plurality of polymer patches or domes 520 integrated with the knitted textile 530, is sandwiched in between the conductive electrode layers 550. In the embodiments shown herein, the electrodes 552 and the domes 520 are arranged in symmetrical, grid-like arrays. In other embodiments, the electrodes 552 and the domes 520 can be arranged asymmetrically throughout the conductive electrode layers 550 and the dielectric knitted core 510. In yet other embodiments, the electrodes 552 and the domes 520 can be arranged symmetrically but not in a grid-like pattern. Notably, the conductive electrode layers 550 are positioned around the dielectric knitted core 510 such that the polymer domes 520 are sandwiched between stretchable electrodes 552.

This disclosure is also directed to methods of manufacturing textile-integrated sensors such as the capacitive sensors discussed above with respect to FIGS. 1-5. The method can include forming a dielectric knitted core, forming two conductive electrode layers, and forming conductive shielding layers. Forming the dielectric knitted core can include providing a knitted textile and depositing polymer patches or domes onto the knitted textile to form a dielectric knitted core. Depositing the polymer patches onto the knitted textile can include locally depositing the polymer patches using a three-axis automated fluid dispensing robot or a syringe dispenser. Optionally, the polymer patches can be deposited using a 25-gauge dispense tip. Upon being placed onto the knitted textile, the polymer patches will at least partially penetrate the knitted textile, such that each polymer patch has a first portion comprising a patch or dome of polymer material sitting on top of the knitted textile and a second portion beneath the first portion that comprises the knitted textile integrated with the polymer material. Once the polymer patches are deposited onto the knitted textile, the polymer patches and the knitted textile are cured to form the dielectric knitted core. In some embodiments of the method, the polymer patches and the knitted core are cured at 120° C. for 10 minutes.

Next, forming each conductive electrode layer can include depositing ink-based, stretchable electrodes onto a polymer film, such as a flexible printed circuit. This can include locally depositing the ink-based electrodes using a three-axis automated fluid dispensing robot or using a syringe dispenser. Optionally, the ink-based electrodes can be deposited using a 27-gauge dispense tip. The ink can be a stretchable silver ink. After the ink-based, stretchable electrodes are deposited onto the polymer film, the conductive electrode layer can be dried in an ambient environment for 20 minutes and then cured. Optionally, the conductive electrode layer can be cured at 120° C. for 5 minutes.

The final layers of the capacitive sensor are the conductive shielding layers. The conductive shielding layers can be formed by providing conductive fabric layers. The conductive fabric layers can be trimmed to be the same shape as the conductive electrode layer-or more specifically, the polymer film of the conductive electrode layer.

The conductive electrode layers and the conductive shielding layers are then engraved with a laser cutter. In particular, openings are laser cut into the polymer film and the conductive fabric tape such that openings are in between the stretchable electrodes when the conductive electrode layers and the conductive shielding layers are stacked. The openings can be used as fiducials when stacking the layers together to form the capacitive sensor, which is described below.

After each individual layer has been formed, the layers can be assembled or stacked to form the capacitive sensor. First, one conductive layer is placed on each side or surface of the dielectric knitted core. The conductive layers should be positioned so that the stretchable electrodes align with and contact the polymer patches. That is, a polymer patch should have one electrode on top of it and one electrode beneath it. Next, one conductive shielding layer is placed on each conductive layer, such that the conductive electrode layers and the conductive shielding layers are symmetrical around the dielectric knitted core.

In another embodiment of the method, a conductive shielding layer is first placed on each conductive electrode layer. The conductive shielding layers contact the side of the conductive electrode layer that does not include the stretchable electrodes. Next, the conductive shielding layer and the conductive electrode layer are engraved with the openings described above. One conductive shielding layer and one conductive electrode layer are then positioned on each side of the dielectric knitted core, such that the stretchable electrodes align with and contact the polymer patches.

Finally, after the capacitive sensor is assembled, the capacitive sensor is laminated. In some embodiments, the capacitive sensor is laminated using an automatic bonding machine. Optionally, the lamination occurs at 140° C. and 12 Bar for 25 seconds. In other embodiments, each layer of the capacitive sensor is laminated before the layers are assembled into the capacitive sensor.

(A1) FIGS. 4A and 4B illustrate cross-sectional side views of the textile-integrated sensor (which can also be referred to as the capacitive sensor), in accordance with some embodiments. The textile-integrated sensor can include a capacitive sensor 400 that comprises a dielectric knitted core 410, a first conductive electrode layer 450A positioned on a top surface 432 of the dielectric knitted core 410, and a second conductive electrode layer 450B positioned on a bottom surface 434 of the dielectric knitted core 410. A first portion 422 of each deformable polymer patch 420 extends above the top surface 432 and a second portion 424 of each deformable polymer patch 420 penetrates the dielectric knitted core 410. Moreover, the first and second conductive electrode layers 450 respectively comprise first and second pluralities of stretchable electrodes 452. The plurality of deformable polymer patches 420 is configured to stiffen regions 440 of the dielectric knitted core 410 corresponding to the first and second pluralities of stretchable electrodes 452 to limit strain on the first and second pluralities of stretchable electrodes 452.

(A2) In some embodiments of A1, the capacitive sensor 400 is configured to receive binary contact inputs, analog force inputs, one-dimensional inputs, and two-dimensional inputs provided to the device.

(A3) In some embodiments of A1-A2, the capacitive sensor 400 has a thickness between 1.0 mm and 2.0 mm.

(A4) In some embodiments of A1-A3, the dielectric knitted core 410 includes a knitted textile 430 comprising polyester and spandex.

(A5) In some embodiments of A1-A4, the first portion 422 of each deformable polymer patch 420 is configured to provide tactile feedback to a wearer of the device.

(A6) In some embodiments of A1-A5, each deformable polymer patch 420 comprises silicone rubber.

(A7) In some embodiments of A1-A6, each deformable polymer patch 420 comprises a cylindrical dome with a height-to-diameter ratio between 0.1 and 0.3 and a diameter between 1490 μm and 1590 μm.

(A8) In some embodiments of A1-A7, the first and second conductive electrode layers 450 are positioned such that each deformable polymer patch 420 is between a first electrode 452A from the first plurality of stretchable electrodes and a second electrode 452B from the second plurality of stretchable electrodes, and the regions 440 of the dielectric knitted core 410 corresponding to the first and second pluralities of stretchable electrodes 452 comprise a region of the dielectric knitted core 410 surrounding each deformable polymer patch 420.

(A9) In some embodiments of A1-A8, each stretchable electrode 452 comprises a silver ink.

(A10) In some embodiments of A1-A9, each conductive electrode layer 450 further comprises stretchable interconnects (e.g., stretchable interconnects 554 in FIG. 5), the stretchable interconnects comprising silver ink.

(A11) In some embodiments of A1-A10, each stretchable electrode 452 comprises a width between 300 μm and 320 μm.

(A12) In some embodiments of A1-A11, the capacitive sensor 400 further comprises a conductive textile shielding layer 460 on each of the first and second conductive electrode layers 450A, 450B, opposite the dielectric knitted core 410.

(A13) In some embodiments of A12, the first and second conductive electrode layers 450A, 450B and each conductive textile shielding layer 460 comprise a plurality of openings, each opening being configured to redistribute strain away from each stretchable electrode of the first and second pluralities of stretchable electrodes.

(A14) In some embodiments of A12-A13, each conductive textile shielding layer 460 comprises conductive fabric tape.

(A15) In some embodiments of A1-A14, the device comprises a hand-worn device.

(B1) In accordance with some embodiments, a method of operating a capacitive sensor 400 that corresponds to any of A1-A15, the method comprising providing a signal from a wearable device to the capacitive sensor 400.

(C1) In accordance with some embodiments, a system comprising an extended- reality device that is in communication with a signal processor and a wearable input device that includes a capacitive sensor and the signal processor for receiving inputs provided by a wearer. The capacitive sensor in this system corresponds to any of A1-A15.

### Example Extended-Reality Systems

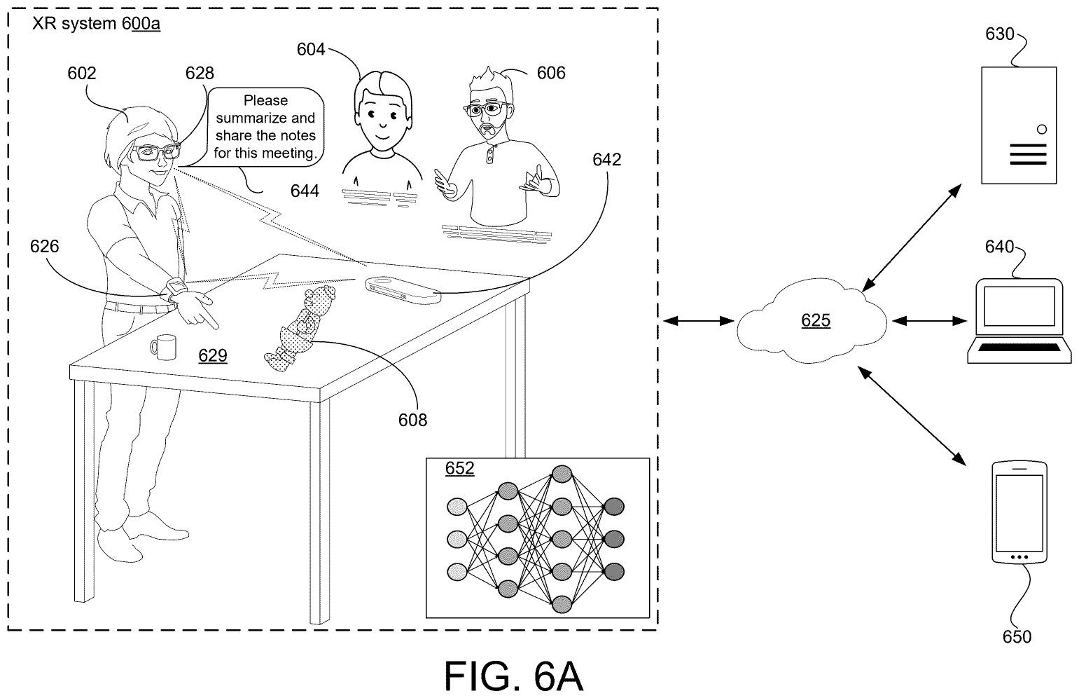

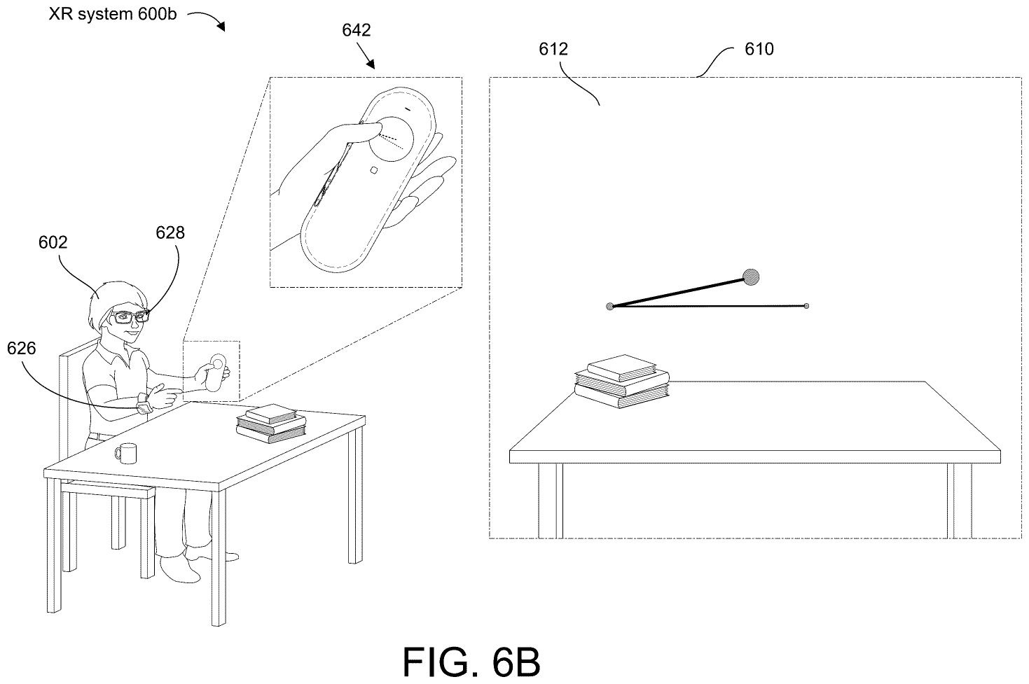

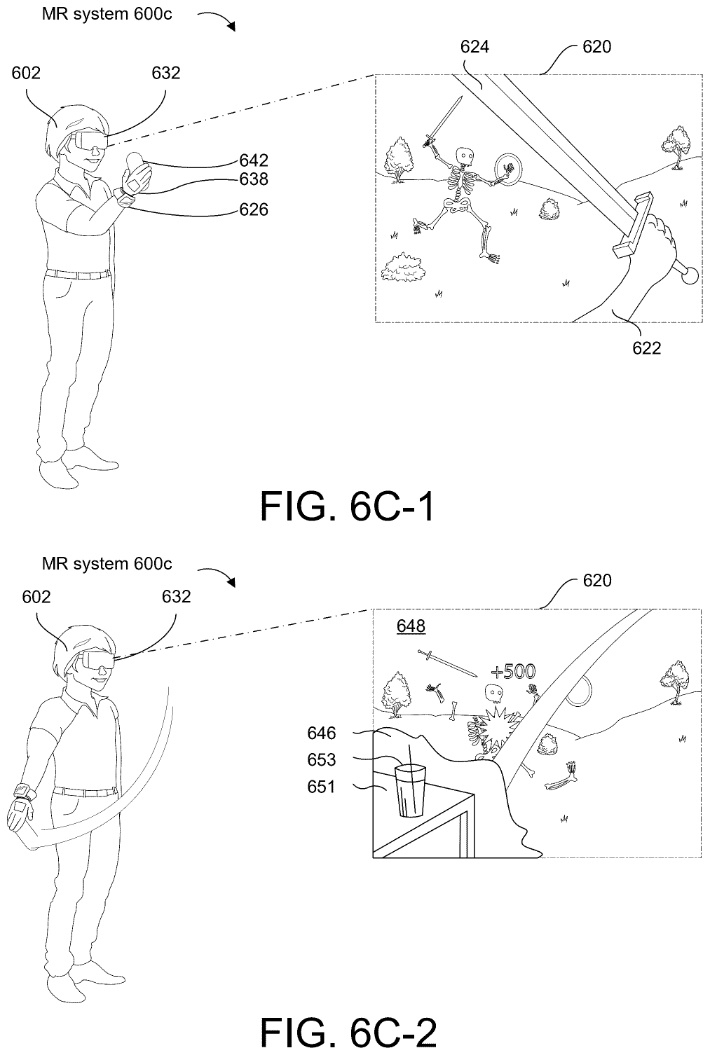

FIGS. 6A 6B, 6C-1, and 6C-2, illustrate example XR systems that include AR and MR systems, in accordance with some embodiments. FIG. 6A shows a first XR system 600aand first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602's eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

### Integration of Artificial Intelligence With XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud- computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602's field of view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602's gestures performed on the HIPD 642 can be provided and/or displayed on another device. For example, the user 602's swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors (e.g., SLAM cameras or other cameras) of the HIPD 642 can be used to detect a position of the HIPD 642 relative to the user 602's body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602's movements; and image sensors of the MR device 632 can be used to represent the user 602's body, boundary conditions, or real-world objects within the first MR game environment 620.

In FIG. 6C-2, the user 602 performs a downward swing while holding the HIPD 642. The user 602's downward swing is detected by the wrist-wearable device 626, the MR device 632, and/or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 651 and cup 653). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602's movements (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602's motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1-5. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A capacitive sensor in a device, the capacitive sensor comprising:
a dielectric knitted core comprising a plurality of deformable polymer patches deposited on a top surface of the dielectric knitted core, wherein a first portion of each deformable polymer patch extends above the top surface and a second portion of each deformable polymer patch penetrates the dielectric knitted core;
a first conductive electrode layer positioned on the top surface of the dielectric knitted core, the first conductive electrode layer comprising a first plurality of stretchable electrodes; and
a second conductive electrode layer positioned on a bottom surface of the dielectric knitted core, the bottom surface opposite the top surface, the second conductive electrode layer comprising a second plurality of stretchable electrodes,
wherein the plurality of deformable polymer patches are configured to stiffen regions of the dielectric knitted core corresponding to the first and second pluralities of stretchable electrodes to limit strain on the first and second pluralities of stretchable electrodes.

2. The capacitive sensor of claim 1, wherein the capacitive sensor is configured to receive binary contact inputs, analog force inputs, one-dimensional inputs, and two-dimensional inputs provided to the device.

3. The capacitive sensor of claim 1, wherein the capacitive sensor has a thickness between 1.0 mm and 2.0 mm.

4. The capacitive sensor of claim 1, wherein the dielectric knitted core includes a knitted textile comprising polyester and spandex.

5. The capacitive sensor of claim 1, wherein the first portion of each deformable polymer patch is configured to provide tactile feedback to a wearer of the device.

6. The capacitive sensor of claim 1, wherein each deformable polymer patch comprises silicone rubber.

7. The capacitive sensor of claim 1, wherein each deformable polymer patch comprises a cylindrical dome with a height-to-diameter ratio between 0.1 and 0.3 and a diameter between 1490 μm and 1590 μm.

8. The capacitive sensor of claim 1, wherein the first and second conductive electrode layers are positioned such that each deformable polymer patch is between a first electrode from the first plurality of stretchable electrodes and a second electrode from the second plurality of stretchable electrodes, and the regions of the dielectric knitted core corresponding to the first and second pluralities of stretchable electrodes comprise a region of the dielectric knitted core surrounding each deformable polymer patch.

9. The capacitive sensor of claim 1, wherein each stretchable electrode comprises a silver ink.

10. The capacitive sensor of claim 1, wherein each conductive electrode layer further comprises stretchable interconnects, the stretchable interconnects comprising silver ink.

11. The capacitive sensor of claim 1, wherein each stretchable electrode comprises a width between 300 μm and 320 μm.

12. The capacitive sensor of claim 1, further comprising a conductive textile shielding layer on each of the first and second conductive electrode layers, opposite the dielectric knitted core.

13. The capacitive sensor of claim 12, wherein the first and second conductive electrode layers and each conductive textile shielding layer comprise a plurality of openings, each opening being configured to redistribute strain away from each stretchable electrode of the first and second pluralities of stretchable electrodes.

14. The capacitive sensor of claim 12, wherein each conductive textile shielding layer comprises conductive fabric tape.

15. The capacitive sensor of claim 1, wherein the device comprises a hand-worn device.

16. A method of operating a capacitive sensor, the method comprising providing a signal from a wearable device to the capacitive sensor, the capacitive sensor comprising:
a dielectric knitted core comprising a plurality of deformable polymer patches deposited on a top surface of the dielectric knitted core, wherein a first portion of each deformable polymer patch extends above the top surface and a second portion of each deformable polymer patch penetrates the dielectric knitted core;
a first conductive electrode layer positioned on the top surface of the dielectric knitted core, the first conductive electrode layer comprising a first plurality of stretchable electrodes; and
a second conductive electrode layer positioned on a bottom surface of the dielectric knitted core, the bottom surface opposite the top surface, the second conductive electrode layer comprising a second plurality of stretchable electrodes,
wherein the plurality of deformable polymer patches are configured to stiffen regions of the dielectric knitted core corresponding to the first and second pluralities of stretchable electrodes to limit strain on the first and second pluralities of stretchable electrodes.

17. The method of claim 16, wherein providing the signal comprises providing one or more of binary contact inputs, analog force inputs, one-dimensional inputs, and two-dimensional inputs.

18. A system, comprising:
an extended-reality device that is in communication with a signal processor;
a wearable input device that includes a capacitive sensor and the signal processor for receiving inputs provided by a wearer, wherein the capacitive sensor comprises:
a dielectric knitted core comprising a plurality of deformable polymer patches deposited on a top surface of the dielectric knitted core;
a first conductive electrode layer positioned on the top surface of the dielectric knitted core, the first conductive electrode layer comprising a first plurality of stretchable electrodes; and
a second conductive electrode layer positioned on a bottom surface of the dielectric knitted core, the second conductive electrode layer comprising a second plurality of stretchable electrodes,
wherein the plurality of deformable polymer patches are configured to stiffen regions of the dielectric knitted core corresponding to the first and second pluralities of stretchable electrodes to limit strain on the first and second pluralities of stretchable electrodes; and
wherein the capacitive sensor is configured to provide the input to the signal processor such that the inputs provided by a wearer can be used to perform or cause performance of an operation at the extended-reality device.

19. The system of claim 18, wherein the first and second conductive electrode layers are positioned such that each deformable polymer patch is between a first electrode from the first plurality of stretchable electrodes and a second electrode from the second plurality of stretchable electrodes, and the regions of the dielectric knitted core corresponding to the first and second pluralities of stretchable electrodes comprise a region of the dielectric knitted core surrounding each deformable polymer patch.

20. The system of claim 18, wherein the first and second conductive electrode layers comprise a plurality of openings, each opening being configured to redistribute strain away from each stretchable electrode of the first and second pluralities of stretchable electrodes.
